(19) United States
(12) Patent Application Publication
(10) Pub. No.: US 2019/0042999 A1
(43) Pub. Date: Feb. 7, 2019

(54) SYSTEMS AND METHODS FOR OPTIMIZING PARALLEL TASK COMPLETION

(71) Applicant: LENDINGHOME CORP., San Francisco, CA (US)

(72) Inventors: Eduardo Del Balso, JR., San Francisco, CA (US); Gregory Scott Walker, Granville, OH (US); Ernesto Antonio Villalobos, III, Lewis Center, OH (US); Christopher Neal Sherrard, San Francisco, CA (US); Keith Tom, San Francisco, CA (US)

(21) Appl. No.: 16/100,618

(22) Filed: Aug. 10, 2018

Related U.S. Application Data
(63) Continuation of application No. 15/210,484, filed on Jul. 14, 2016, now abandoned.

(51) Int. Cl. G06Q 10/06; G06Q 40/02; G06N 3/08

(52) U.S. Cl. CPC G06Q 10/063114; G06Q 10/06316; G06N 3/08; G06Q 40/02

(57) ABSTRACT

Implementations of the present disclosure are directed to a method, a system, and a computer program storage device for performing tasks associated with a project. A computer-implemented method includes: collecting data related to tasks that have been completed; training a predictive model using the collected data; matching a product to a customer; using the predictive model to determine weights for uncompleted tasks associated with the product; assigning the weights to the uncompleted tasks; and assigning the uncompleted tasks to a plurality of queues based on the weights, to maximize parallel performance of the tasks and meet a completion date associated with the product.

### CROSS-REFERENCE TO RELATED APPLICATIONS

This application is a continuation of U.S. patent application Ser. No. 15/210,484, filed Jul. 14, 2016, the entire contents of which are hereby incorporated by reference.

### BACKGROUND

This specification relates to a workflow system and, in particular, to a computerized workflow system for optimizing the performance and completion of tasks in parallel.

In general, multi-step processes often include steps that cannot be performed until other steps are completed and usually include certain other steps that can be performed in parallel. For example, the mortgage process includes various steps associated with obtaining financial information from the borrower, defining desired terms of loan products, processing and analyzing financial information, obtaining required signatures, and closing the loan. Some of these tasks (e.g., analyzing financial information) cannot be performed until other tasks (e.g., obtaining the financial information) have been performed. Other tasks can be performed in parallel (e.g., obtaining required signatures and closing the loan). Given the dependencies of the multiple tasks on one another, certain tasks are often left uncompleted, and such multi-step processes can be difficult to complete on time. There is a need for systems and methods that facilitate the process of completing tasks in multi-step processes.

### SUMMARY

Examples of the systems and methods described herein assist with the organization and completion of projects or processes involving multiple steps. Projects or processes are broken down into specific tasks which are prioritized, weighted, and/or assigned to a plurality of project personnel or equipment. Various toolkits are provided that guide project personnel through the completion of tasks and ensure tasks are performed in a proper order and on time. Certain toolkits are provided to supervisors for managing projects and ensuring project personnel and resources are allocated properly.

In some implementations, the systems and methods include or utilize one or more computation layers for efficient implementation of computer systems. The computation layers include one or more modules (e.g., software routines, algorithms, and/or user interfaces) that assist with project planning and execution and guide project personnel through the completion of various project tasks. For example, a framework layer is provided that includes a plurality of modules for generating or providing general purpose toolkits for various projects. A configuration layer is provided that includes a plurality of modules for customizing the general purpose toolkits according to specific project types. The customized toolkits may be used by project personnel to manage and/or complete one or more specific project tasks. An orchestration layer is provided that includes a plurality of modules for monitoring the status of projects, ensuring project tasks are assigned properly, and optimizing use of project resources. In certain examples, the orchestration layer determines and/or considers difficulties and dependencies associated with project tasks. The task difficulties allow the orchestration layer to determine how to assign tasks such that workload is distributed evenly among project personnel and/or equipment. The task dependencies allow the orchestration layer to determine a proper sequence for performing the project tasks. Finally, an execution layer is provided that includes a plurality of modules for assisting project personnel and/or equipment with the performance of project tasks. The execution layer may provide, for example, one or more user interfaces that guide project personnel through project management and/or proper timing and execution of project tasks.

In general, one aspect of the subject matter described in this specification can be embodied in methods that include the actions of performing by one or more computers: collecting task completion data for a plurality of completed tasks, wherein the data for each completed task includes respective task type, task duration, and attributes of a previous customer for whom the task was performed; training a predictive model using the task completion data, the predictive model configured to determine a weight for an uncompleted task, given a task type and attributes of a current customer associated with the uncompleted task; matching a first product of a plurality of products to the current customer, wherein each product includes respective conditions, tasks, and dependencies among the tasks; assigning respective weights to a plurality of uncompleted tasks associated with the first product, the weight for each uncompleted task determined by the predictive model based on input data including a task type of the uncompleted task and attributes of the current customer associated with the uncompleted task; assigning each task in the plurality of uncompleted tasks to a respective queue based on a calculated load of the queue and the weight for the uncompleted task, to maximize parallel performance of the tasks and meet a completion date.

In certain examples, the method includes providing a respective graphical user interface (GUI) associated with each queue wherein the GUI includes a progress indicator for each task in the queue. The method may include updating a particular GUI based on a progress of tasks in the associated queue. The weight for an uncompleted task may include a predicted time to complete the task. In one example, the weight for an uncompleted task includes a predicted complexity of the task. In various instances, the attributes of the current customer include at least two of an indication of credit worthiness of the current customer, responsiveness of the current customer, and attributes of property the current customer wants to purchase. Assigning each task to a respective queue may include balancing a workload associated with a plurality of queues.

In some examples, a particular uncompleted task requires obtaining input data, and the method includes: automatically identifying one or more data fields of an electronic document; and automatically extracting respective values of the data fields from the document. A particular task may be associated with one or more input data fields, and the method may include: identifying an electronic source document from which the particular data field was extracted; and providing a view of the data field in the source document in a graphical user interface. In certain instances, the first product is a loan product having conditions that include a loan amount and an interest rate.

In various implementations, the method includes determining in a time period after the matching and based on conditions of the first product that the first product is no longer a match for the current customer and, based thereon, matching a different second product of the plurality of products to the current customer. The method may include: assigning respective second weights to a plurality of uncompleted tasks associated with the second product, the second weights determined by the predictive model based on input data including a task type and attributes of the current customer; and assigning each task in the plurality of uncompleted tasks associated with the second product to a respective queue based on a calculated load of the queue and the second weights, to maximize parallel performance of the uncompleted tasks associated with the second product and to meet a second completion date.

In certain examples, the method includes determining that the completion date will not be met and, based thereon, reassigning one or more of the first product uncompleted tasks to one or more different queues in order to meet the completion date. Assigning a particular task to a particular queue may include: determining a priority of the particular task based on one or more attributes of the customer, the first product, and attributes of property the customer wants to purchase; and inserting the particular task into the particular queue at a position based on the priority of the task. The position may be ahead of one or more other tasks in the queue.

In various instances, the predictive model is a statistical classifier. The previous customer and the current customer may be different customers. The task completion data for each completed task may include conditions of a product associated with the completed task. In some examples, assigning a task in the plurality of uncompleted tasks includes assigning the task after a prior task has been completed.

In another aspect, the subject matter described herein relates to a system that includes a non-transitory computer readable medium having instructions stored thereon, and a data processing apparatus configured to execute the instructions to perform operations including: collecting task completion data for a plurality of completed tasks, wherein the data for each completed task includes respective task type, task duration, and attributes of a previous customer for whom the task was performed; training a predictive model using the task completion data, the predictive model configured to determine a weight for an uncompleted task, given a task type and attributes of a current customer associated with the uncompleted task; matching a first product of a plurality of products to the current customer, wherein each product includes respective conditions, tasks, and dependencies among the tasks; assigning respective weights to a plurality of uncompleted tasks associated with the first product, the weight for each uncompleted task determined by the predictive model based on input data including a task type of the uncompleted task and attributes of the current customer associated with the uncompleted task; assigning each task in the plurality of uncompleted tasks to a respective queue based on a calculated load of the queue and the weight for the uncompleted task, to maximize parallel performance of the tasks and meet a completion date.

In certain examples, the operations include providing a respective graphical user interface (GUI) associated with each queue wherein the GUI includes a progress indicator for each task in the queue. The operations may include updating a particular GUI based on a progress of tasks in the associated queue. The weight for an uncompleted task may include a predicted time to complete the task. In one example, the weight for an uncompleted task includes a predicted complexity of the task. In various instances, the attributes of the current customer include at least two of an indication of credit worthiness of the current customer, responsiveness of the current customer, and attributes of property the current customer wants to purchase. Assigning each task to a respective queue may include balancing a workload associated with a plurality of queues.

In some examples, a particular uncompleted task requires obtaining input data, and the operations include: automatically identifying one or more data fields of an electronic document; and automatically extracting respective values of the data fields from the document. A particular task may be associated with one or more input data fields, and the operations may include: identifying an electronic source document from which the particular data field was extracted; and providing a view of the data field in the source document in a graphical user interface. In certain instances, the first product is a loan product having conditions that include a loan amount and an interest rate.

In various implementations, the operations include determining in a time period after the matching and based on conditions of the first product that the first product is no longer a match for the current customer and, based thereon, matching a different second product of the plurality of products to the current customer. The operations may include: assigning respective second weights to a plurality of uncompleted tasks associated with the second product, the second weights determined by the predictive model based on input data including a task type and attributes of the current customer; and assigning each task in the plurality of uncompleted tasks associated with the second product to a respective queue based on a calculated load of the queue and the second weights, to maximize parallel performance of the uncompleted tasks associated with the second product and to meet a second completion date.

In certain examples, the operations include determining that the completion date will not be met and, based thereon, reassigning one or more of the first product uncompleted tasks to one or more different queues in order to meet the completion date. Assigning a particular task to a particular queue may include: determining a priority of the particular task based on one or more attributes of the customer, the first product, and attributes of property the customer wants to purchase; and inserting the particular task into the particular queue at a position based on the priority of the task. The position may be ahead of one or more other tasks in the queue.

In various instances, the predictive model is a statistical classifier. The previous customer and the current customer may be different customers. The task completion data for each completed task may include conditions of a product associated with the completed task. In some examples, assigning a task in the plurality of uncompleted tasks includes assigning the task after a prior task has been completed.

In another aspect, the subject matter described herein relates to a computer program product stored in one or more non-transitory storage media for controlling a processing mode of a data processing apparatus, the computer program product being executable by the data processing apparatus to cause the data processing apparatus to perform operations that include: collecting task completion data for a plurality of completed tasks, wherein the data for each completed task includes respective task type, task duration, and attributes of a previous customer for whom the task was performed; training a predictive model using the task completion data, the predictive model configured to determine a weight for an uncompleted task, given a task type and attributes of a current customer associated with the uncompleted task; matching a first product of a plurality of products to the current customer, wherein each product includes respective conditions, tasks, and dependencies among the tasks; assigning respective weights to a plurality of uncompleted tasks associated with the first product, the weight for each uncompleted task determined by the predictive model based on input data including a task type of the uncompleted task and attributes of the current customer associated with the uncompleted task; assigning each task in the plurality of uncompleted tasks to a respective queue based on a calculated load of the queue and the weight for the uncompleted task, to maximize parallel performance of the tasks and meet a completion date.

In certain examples, the operations include providing a respective graphical user interface (GUI) associated with each queue wherein the GUI includes a progress indicator for each task in the queue. The operations may include updating a particular GUI based on a progress of tasks in the associated queue. The weight for an uncompleted task may include a predicted time to complete the task. In one example, the weight for an uncompleted task includes a predicted complexity of the task. In various instances, the attributes of the current customer include at least two of an indication of credit worthiness of the current customer, responsiveness of the current customer, and attributes of property the current customer wants to purchase. Assigning each task to a respective queue may include balancing a workload associated with a plurality of queues.

In some examples, a particular uncompleted task requires obtaining input data, and the operations include: automatically identifying one or more data fields of an electronic document; and automatically extracting respective values of the data fields from the document. A particular task may be associated with one or more input data fields, and the operations may include: identifying an electronic source document from which the particular data field was extracted; and providing a view of the data field in the source document in a graphical user interface. In certain instances, the first product is a loan product having conditions that include a loan amount and an interest rate.

In various implementations, the operations include determining in a time period after the matching and based on conditions of the first product that the first product is no longer a match for the current customer and, based thereon, matching a different second product of the plurality of products to the current customer. The operations may include: assigning respective second weights to a plurality of uncompleted tasks associated with the second product, the second weights determined by the predictive model based on input data including a task type and attributes of the current customer; and assigning each task in the plurality of uncompleted tasks associated with the second product to a respective queue based on a calculated load of the queue and the second weights, to maximize parallel performance of the uncompleted tasks associated with the second product and to meet a second completion date.

In certain examples, the operations include determining that the completion date will not be met and, based thereon, reassigning one or more of the first product uncompleted tasks to one or more different queues in order to meet the completion date. Assigning a particular task to a particular queue may include: determining a priority of the particular task based on one or more attributes of the customer, the first product, and attributes of property the customer wants to purchase; and inserting the particular task into the particular queue at a position based on the priority of the task. The position may be ahead of one or more other tasks in the queue.

In various instances, the predictive model is a statistical classifier. The previous customer and the current customer may be different customers. The task completion data for each completed task may include conditions of a product associated with the completed task. In some examples, assigning a task in the plurality of uncompleted tasks includes assigning the task after a prior task has been completed.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF THE DRAWINGS

FIG. 1 is a schematic diagram of an example system for performing the tasks of a project.

FIG. 2 is a schematic diagram of an example predictive model being developed using training data.

FIG. 3 is a schematic diagram of an example predictive model being used to calculate weights for a plurality of tasks.

FIG. 4A is a schematic tree diagram of a plurality of tasks associated with a project, in accordance with certain examples of this disclosure.

FIG. 4B is a schematic tree diagram showing weights for the tasks in the project of FIG. 4A, in accordance with certain examples of this disclosure.

FIG. 5 is an example subsystem for distributing and completing tasks associated with a project.

FIG. 6 is a screenshot of a portion of an example configuration file in accordance with this disclosure.

FIG. 7 is a screenshot of example syntax for a configuration file in accordance with this disclosure.

FIG. 8 is a screenshot of an example checklist index in accordance with this disclosure.

FIG. 9 is a screenshot of an example pipeline in accordance with this disclosure.

FIG. 10 is a screenshot of an example user interface for confirming data associated with a project.

FIG. 11 is a screenshot of an example loan document in accordance with this disclosure.

FIG. 12 is a schematic diagram of a system for optimizing parallel task completion in accordance with this disclosure.

FIG. 13 is a flowchart of an example method of optimizing parallel task completion in accordance with this disclosure.

### DETAILED DESCRIPTION

In general, the systems and methods described herein are used to make multi-step processes or projects more efficient and more likely to be completed on time. The systems and methods involve breaking multi-step projects into a plurality of discrete tasks. The tasks are identified as being either independent or dependent. Independent tasks can be performed without first doing any other tasks associated with the project. Dependent tasks can be performed only after one or more other tasks have been completed. The systems and methods identify such dependencies to determine when each task can be performed.

In certain examples, the systems and methods track the progress associated with the performance of the tasks. As certain tasks are completed, the systems and methods identify any subsequent, dependent tasks that can now be performed. Tasks that can be performed simultaneously may be assigned to parallel processes. Tasks may be performed by one or more computers and/or one or more people.

The systems and methods preferably monitor the progress of multistep projects and calculate an estimated time for completion of the project. The estimated time may be based on various factors, including, for example, the time associated with each remaining task, the ability of one or more people who are associated with one or more tasks, the presence and timing of any dependent tasks, and the availability of performing two or more tasks in parallel. The estimated time is periodically compared with a targeted time for completion of the project. When the estimated completion time is later than the targeted completion time, the systems and methods may take corrective action. The corrective action may include, for example, assigning one or more tasks to additional processes (e.g., computers and/or people), reassigning one or more tasks to different processes, changing an order in which one or more tasks are performed, modifying one or more tasks, and/or eliminating one or more tasks.

The project for which the systems and methods are used may be any type of multi-step project. The project may be or may be associated with, for example, a manufacturing project (e.g., manufacturing a machine), a maintenance project, a construction project, an application project (e.g., processing a mortgage or college application), a legal project (e.g., handling a litigation), or an event (e.g., a show or a convention).

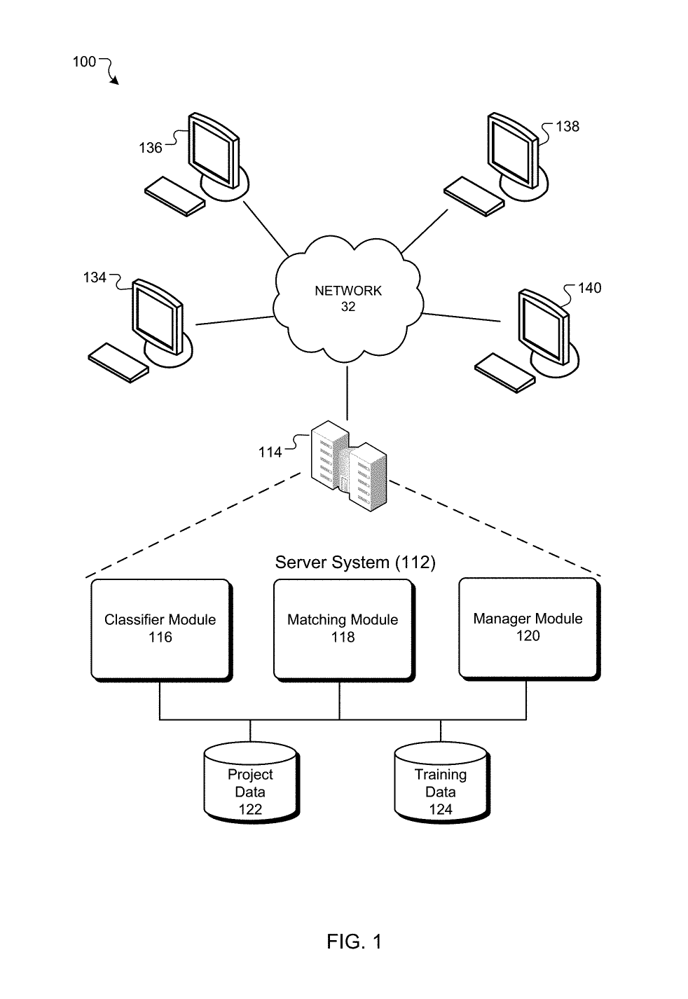

FIG. 1 illustrates an example system 100 for performing a multi-step project. A server system 112 provides data retrieval, project task analysis, and project monitoring. The server system 112 comprises one or more processors 114, software components, and databases that can be deployed at various geographic locations or data centers. The server system 112 software components include a classifier module 116, a matching module 118, and a manager module 120. The software components can include subcomponents that can execute on the same or on different individual data processing apparatus. The server system 112 databases include project data 122 and training data 124. The databases can reside in one or more physical storage systems. The software components and data will be further described below.

An application having a graphical user interface can be provided as an end-user application to allow users to exchange information with the server system 12. The end-user application can be accessed through a network 32 (e.g., the Internet and/or a local network) by users of client devices. In the depicted example, the client devices include supervisor client device 134 and user client devices 136, 138, and 140. Each client device may be, for example, a personal computer, a smart phone, a tablet computer, or a laptop computer. Other client devices are possible.

Although FIG. 1 depicts the classifier module 116, the matching module 118, and the manager module 120 as being connected to the databases (i.e., project data 122 and training data 124), the classifier module 116, the matching module 118, and/or the manager module 20 are not necessarily connected to one or both of the databases. In general, the classifier module 116 is trained using the training data 124. The manager module 120 may use project data 122 and output from the classifier module 116 to determine how project tasks are to be performed.

In general, the matching module 118 is used to match one item to another item. In the context of a business relationship, for example, the matching module may be used to match a customer with a product. In the context of a loan, the matching module 118 may match a customer with a loan product, based on characteristics of the customer and/or desired conditions of the loan. For example, the matching module may consider a customer's desired down payment, loan term, and/or monthly payment to determine a most suitable product for the customer. In some instances, when a customer's characteristics (e.g., credit rating or income) and/or desired loan conditions change, the matching module is able to recalibrate and/or determine a more suitable product for the customer. The more suitable product may include, for example, an interest rate, a loan amount, and/or a monthly payment that are a better match for the customer. Once the more suitable product is identified, any new or modified tasks associated with the product can be assigned and performed as described herein.

The customer may be an entity (e.g., a company, a corporation, or a machine) or a person for whom a project or service is being performed. The customer may be an individual who is buying property, goods, or services, or an individual who is supervising work done by others. In a preferred implementation, the customer is an applicant for a loan or mortgage.

In one example, the system 100 is used to assist with the performance of tasks associated with a loan or mortgage. The training data 124 in this case includes data associated with prior mortgages, including, for example, borrower attributes, mortgage task types, mortgage task duration, and/or mortgage product attributes, for a collection of prior mortgages. The training data 124 is used to train one or more predictive models (e.g., classifiers) in the classifier module 116, so that predictions can be made for new mortgages. For example, the classifier module 116 can be used to predict how long various tasks associated with a new mortgage will take. Information about the new mortgage, including loan applicant attributes and loan conditions (e.g., loan term, interest rate, loan amount, etc.), is preferably stored in the project data 122. Once trained, the classifier module 116 is able to recognize patterns from prior mortgages so that new mortgage projects can be managed efficiently. A primary goal of the mortgage process is to close the mortgage on schedule. The systems and methods can be used to ensure mortgage associated tasks are completed efficiently so closing is reached, without delay.

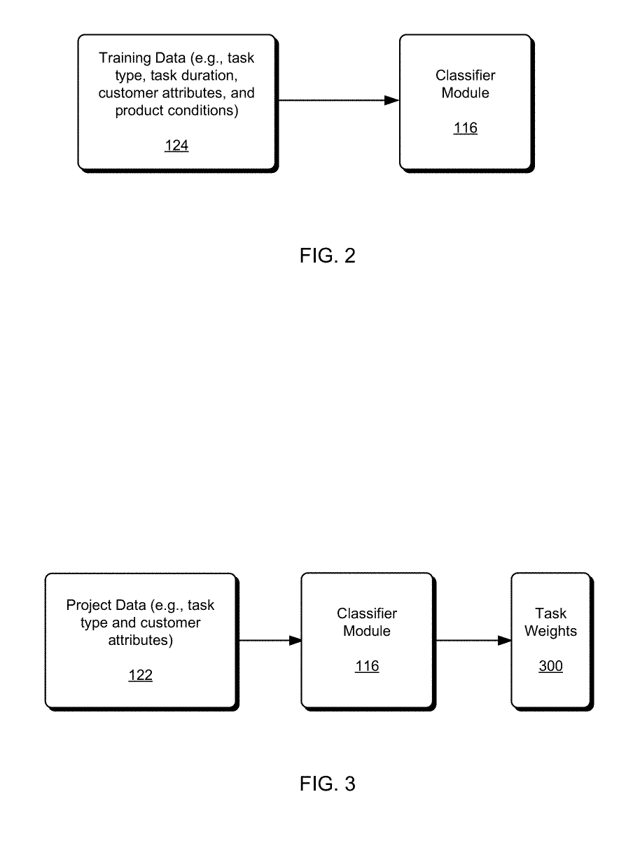

FIG. 2 is a schematic diagram of an example method of developing the classifier module 116 for determining weights associated with tasks of a project. The classifier module 116 preferably is or includes a classifier or similar algorithm that is trained with the training data 124 to predict time to complete a task or difficulty/complexity of a task. The classifier module 116 may be or may use, for example, a linear classifier (e.g., Fisher's linear discriminant, logistic regression, Naive Bayes classifier, or perceptron), support vector machines (e.g., least squares support vector machines), a quadratic classifier, a kernel estimator (e.g., k-nearest neighbor), a boosting (meta-algorithm) classifier, a decision trees classifier (e.g., random forests), a neural networks classifier, a statistical classifier, and/or learning vector quantization. The training data 124 may include information for a plurality of completed tasks. For example, in the context of loans or mortgages, the training data may be or include information related to the types of tasks performed (e.g., performing credit checks, performing background checks, reviewing bank statements, obtaining signed documents, etc.), the length of time it took to perform the tasks (e.g., in hours or days), how difficult it was to complete the task (e.g., on a scale of 1 to 10, with 10 being most difficult), attributes of the loan applicant or customer (e.g., credit rating, income, payment history, previous experience with the customer, responsiveness of the customer, etc.), and conditions related to the loan product (e.g., amount of the loan, term of the loan, interest rate, down payment amount, value of property being purchased, etc.).

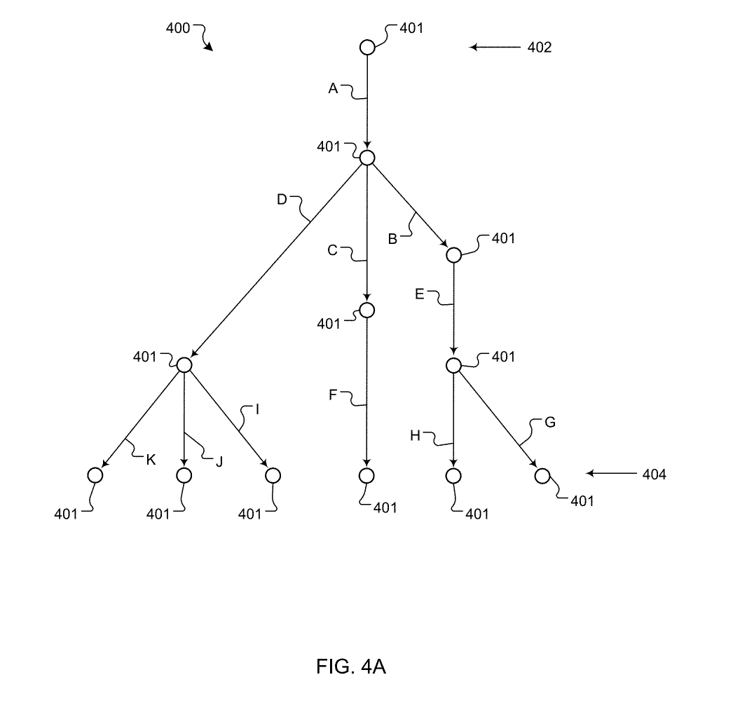

Referring to FIG. 3, after the classifier module 116 has been trained with the training data 124, the classifier module 116 can be used to predict certain characteristics related to the completion of tasks in a project. In the context of a new loan, for example, the classifier module 116 may be provided with the project data 122 for the new loan. The project data 122 may be or include, for example, information about the loan applicant or customer (e.g., credit rating, credit worthiness, income, responsiveness, information regarding the property to be purchased, etc.), loan conditions (e.g., interest rate, term, loan amount, etc.), and tasks that must be performed to close the loan (e.g., perform credit check, review bank statements, obtained signed documents, etc.). The classifier module 116 receives the project data 122 and provides predictions related to the new loan. For example, the classifier module 116 may predict weights 300 associated with tasks that need to be performed to close the new loan. In certain instances, a weight for a task is or includes a predicted time it will take to complete the task, an estimate of how difficult it will be to complete the task, and/or a measure of a complexity of the task.

In some examples, a customer may be a repeat customer, such that information about the customer is in the training data 124 used to train the classifier module 116 and in the project data 122 used by the classifier module 116 to determine weights. In general, when a customer is a repeat customer, certain predictions related to the performance of the customer will be more accurate. For example, if the repeat customer was unresponsive during a previous project, the customer is likely to be unresponsive in a subsequent project. Such information can be used to predict when certain tasks that rely on the customer will be completed, and appropriate weights can be assigned to such tasks more accurately. Examples of such tasks include, for example, obtaining signatures from the customer and/or certain paperwork or information from the customer.

In certain implementations, the systems and methods described herein are used to match customers with products. For example, based on certain customer criteria and product criteria, the matching module 118 may determine one or more products that are suitable for the customer. In the context of a loan, for example, the matching module 118 may receive attributes of a loan applicant (e.g., income, credit rating, desired loan amount, etc.) and identify a loan product that is consistent with the loan applicant's attributes. For example, if the loan applicant has a good credit rating, the loan applicant may qualify for a loan product that has a lower interest rate. The loan product identified by the matching module 118 includes certain parameters or conditions (e.g., loan amount, loan term, interest rate, etc.) that may be presented to the loan applicant for review. If the loan applicant decides to apply for the identified loan product, a set of tasks associated with the loan product must then be performed before the loan is closed and the applicant receives the desired funds. The tasks that must be performed prior to closing the loan constitute a loan project that can be performed using the systems and methods described herein.

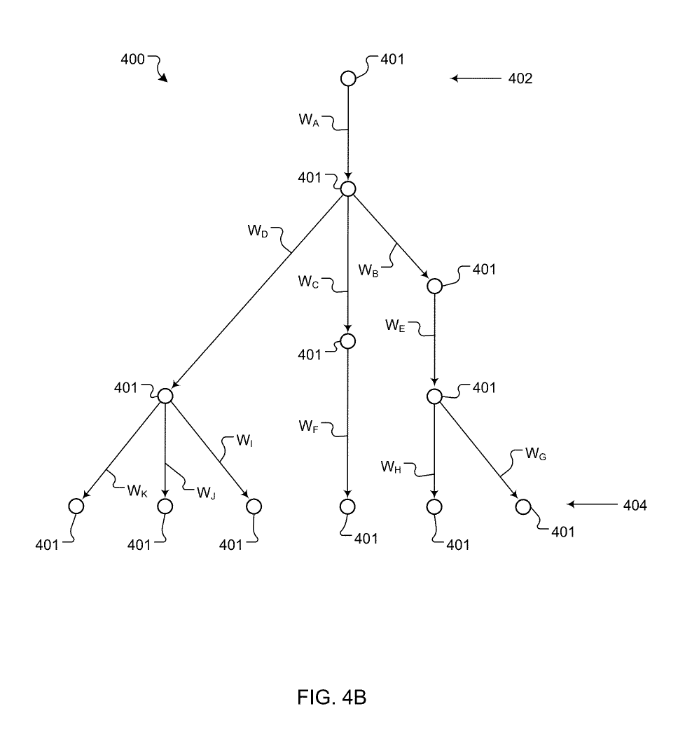

FIG. 4A is an example tree diagram of a project 400, such as a loan project. Each edge or line segment in the diagram represents a task associated with the project 400. Each node 401 on the diagram represents an endpoint of one or more tasks. The project 400 begins at a first location 402 and ends at a second location 404, after all tasks have been completed. As the diagram indicates, the project 400 begins with task A. Subsequent tasks B, C, and D are dependent tasks and cannot be performed until step A is completed. In the mortgage context, task A may be, for example, receiving a request for a loan from a borrower. Tasks B, C, and D are performed after completing task A. Tasks B, C, and D can be performed at the same time or at different times, depending on available resources and available time for completing the project 400. For example, if there are multiple people available to perform tasks A, B, and C, these tasks may be performed by the multiple people, preferably in parallel by assigning the tasks to different queues. Alternatively, if only one person is available to perform tasks A, B, and C, the tasks may be performed in series by that person. In some instances, when it is important to complete the tasks quickly to meet a deadline (e.g., a closing date for a loan), performing the tasks in parallel is preferred.

Continuing on through the project 400, after task B is completed, task E may be performed, followed by tasks G and H, which may be performed in parallel. Tasks G and H depend on task E and cannot be performed until task E is completed; however, tasks G and H do not depend on one another and can therefore be performed in parallel. In general, if two or more tasks do not depend on one another (i.e., one task must be completed before beginning the other task), then the two or more tasks can be performed in parallel. Task F depends on task C and can be performed after task C is completed. Tasks I, J, and K depend on task D and can be performed after task D is completed. Tasks I, J, and K do not depend on one another and may therefore be performed in parallel, if desired. When tasks F through K have been performed, the project 400 is complete.

FIG. 4B is an example tree diagram for the project 400 showing each task in the project 400 having an associated weight. The weight for a task may be, for example, a predicted time it will take to complete the task, an estimate of how difficult it will be to complete the task, and/or a measure of a complexity of the task. Weights W_{A} through W_{K} in FIG. 4B represent the weights for corresponding tasks A though K in FIG. 4A. The weights are preferably determined using the classifier module 116, as described herein.

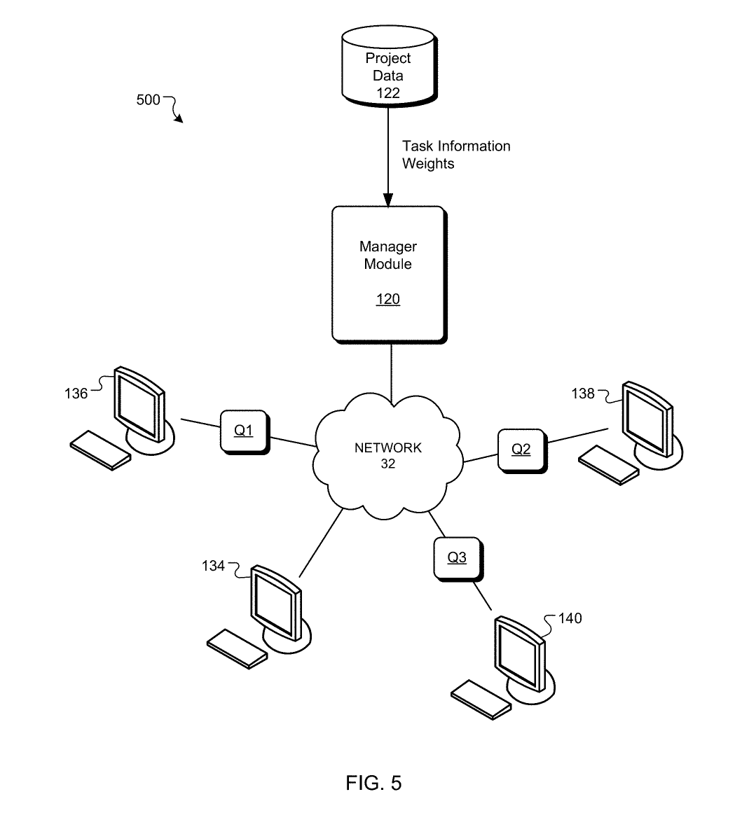

FIG. 5 is a schematic diagram of a subsystem 500 for distributing and completing tasks associated with a project. The subsystem 500 includes the project data 122, the manager module 120, the network 32, the supervisor client device 134, and the user client devices 136, 138, and 140. The system also includes queues Q1, Q2, and Q3 associated with the user client devices 136, 138, and 140, respectively. In an example application, the project relates to completing tasks associated with a loan product. The project data 122 in that case includes information about the loan project including the specific tasks that must be performed and the weights for each task, as determined by the classifier module. The project data 122 is provided to the manager module 120 (e.g., via the network 32), which is used to determine how the project tasks should be distributed.

In various instances, the manager module 120 is in communication with the queues Q1, Q2, and Q3, which may be first-in, first-out data structures stored in server system 112. Each of the queues includes a listing of one or more tasks for the project and information related to the one or more tasks. The related information for each task may be, for example, a priority for the task (e.g., its position in the queue relative to the other tasks), an indication of how much of the task has been completed, an indication of how much more time will be required to complete the task, an indication of the time when work was first performed on the task, an indication of the last time work was done on the task, and, if the task is completed, an indication of the time when the task was completed. The manager module 120 reviews the listing of tasks and task information to determine a load for each queue Q1, Q2, and Q3. In certain instances, the load provides an indication of how much work is required to complete the tasks listed in a queue. For example, the load for a queue may be or include a measure of an amount of time required to complete all of the listed tasks in the queue. Alternatively or additionally, the load for a queue may be a measure of how difficult it will be to complete all of the listed tasks in the queue. This may be determined based on weights associated with the queue. For example, the load for a queue may be the sum of the weights associated with that queue. In some instances, the load for a queue is a measure of a rate at which work is being done for the queue. In some implementations, each queue provides an order for performing each task.

In general, the manager module 120 manages the workload in each queue so that tasks are completed efficiently and on time. When a task is completed, new tasks that depend on the completed task may then be performed and are ready to be assigned. The manager module 120 may review the load in each queue and determine how the new tasks should be assigned. The manager module 120 also considers whether tasks can be performed in parallel. For example, if two tasks can be performed in parallel, the manager module 120 will preferably assign each of the two tasks to a separate queue. This allows the people and/or machines associated with the separate queues to perform the two tasks in parallel. The manager module 120 also preferably monitors the load in each queue and adjusts the loads as needed. For example, if the load in one queue is disproportionately high, the manager module 120 may reassign one or more tasks in the queue to one or more other queues. By monitoring the loads in the queues and assigning and/or reassigning tasks based on the loads, the manager module 120 can achieve an efficient use or resources and reduce the total time it takes to complete the project.

Alternatively or additionally, tasks may be assigned based on capabilities associated with performing tasks in a queue. For example, if a queue is associated with a more experienced person and/or a more capable machine, that queue may be assigned tasks having greater complexity and/or requiring specific skills or experience. Likewise, tasks that are simpler to perform and/or require less expertise may be assigned to queues associated with less experienced people and/or less capable machines.

In some applications, tasks are assigned based on work capacities associated with one or more queues. For example, a queue may have a measured or predetermined work capacity that provides an indication of an amount of work that can be performed in the queue over a given period of time. Queues associated with more efficient people or machines may have higher work capacities. In general, queues with higher work capacities may be assigned more tasks, over time, compared to queues having lower work capacities.

Alternatively or additionally, tasks may be assigned according to a role associated with one or more users or machines. For example, a user or a machine may have a particular role in a project, and tasks associated with the role may be assigned to that particular user or machine. In the context of a loan project, for example, a user may be assigned to the role of underwriter, and all or some of the project tasks associated with underwriting may be assigned to that particular user.

In certain implementations, the tasks in a queue are performed by a person or process associated with the queue. For example, the tasks in queue Q1 may be performed by a user of user client device 136. Likewise, the tasks in queues Q2 and Q3 may be performed by users of user client devices 138 and 140, respectively. Alternatively or additionally, tasks are performed by machines, such as computers, processors, mechanical devices, electrical devices, or electromechanical devices. For example, each queue may be associated with a machine that performs the tasks listed in the queue.

While the example in FIG. 5 depicts three queues, the systems and methods described herein may accommodate or include any number of queues. The number of queues required may depend on the number of tasks in a project, the time available to complete the project, the difficulty of completing the project, and/or a number of projects that need to be completed.

In various examples, the supervisor client device 134 is used by a supervisor who is overseeing the project. The supervisor may use the client device 134 to monitor the status of the tasks in the project. The supervisor may also provide instructions to the manager module 120 regarding how tasks should be assigned or reassigned. In some instances, the manager module 120 is or is controlled by the supervisor.

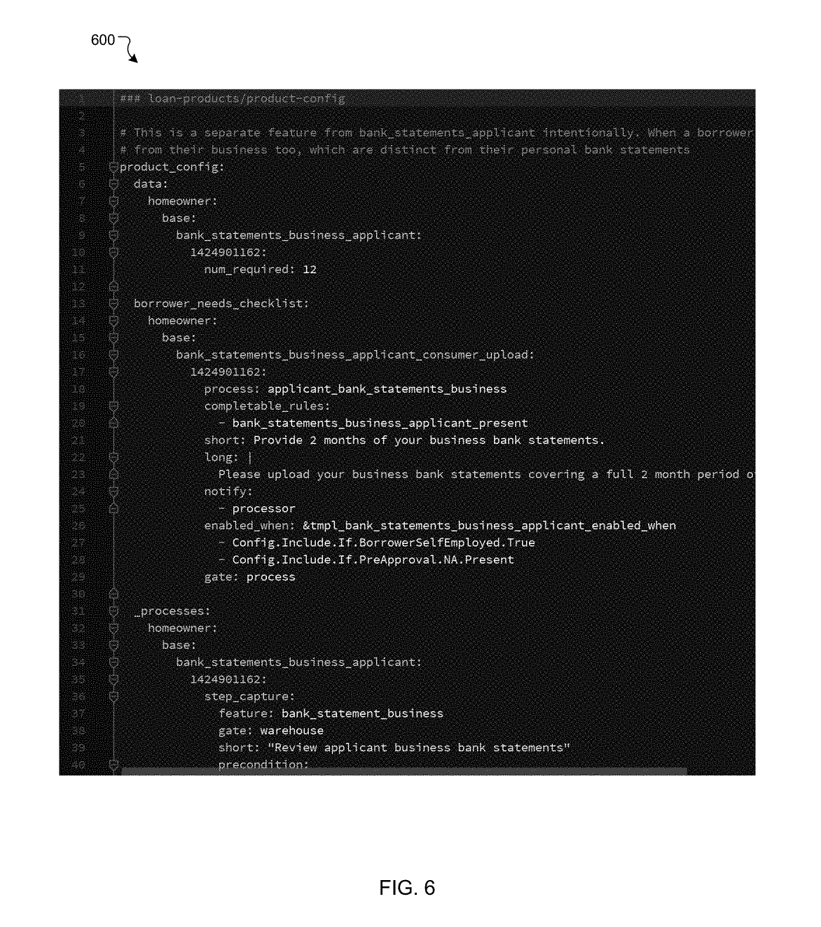

FIG. 6 is a screenshot of a portion of an example configuration file 600 for use with the systems and methods described herein. In general, the configuration file 600 defines the specific tasks that must be performed and/or any rules or requirements for a project or a portion of the project. The configuration file 600 may include, for example, the project data 122 which may input into the classifier module 116. The systems and methods read the information in the configuration file 600 and use the information to identify, perform, organize, and/or monitor the specific project tasks.

In the depicted example, the configuration file 600 is for a loan project that includes multiple tasks that must be performed by various entities, including a borrower, a lender, and an underwriter. In particular, the configuration file 600 describes or includes information about a borrower, a property, and loan terms for the loan project. Information about the borrower may include, for example, income, credit rating, net worth, total debt, etc. Information about the property may include, for example, a street address, an appraised value, and current owner information. The loan terms information may include, for example, interest rate, term, down payment, etc. In the depicted example, the configuration file 600 indicates a borrower may need to provide a bank statement before the loan is finalized.

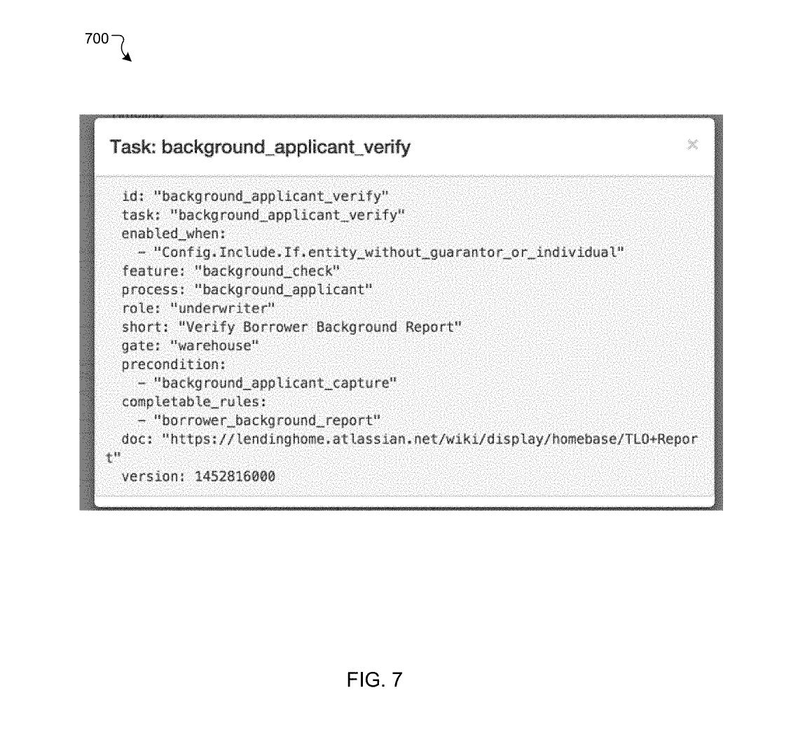

FIG. 7 is a screenshot of example input parameters 700 for a specific task related to verifying a loan applicant's background. The systems and methods described herein use the parameters to determine when a task is required to be performed and who will perform the task. The depicted example indicates that a task of doing a borrower background check will be performed by an underwriter after certain conditions and/or rules are met.

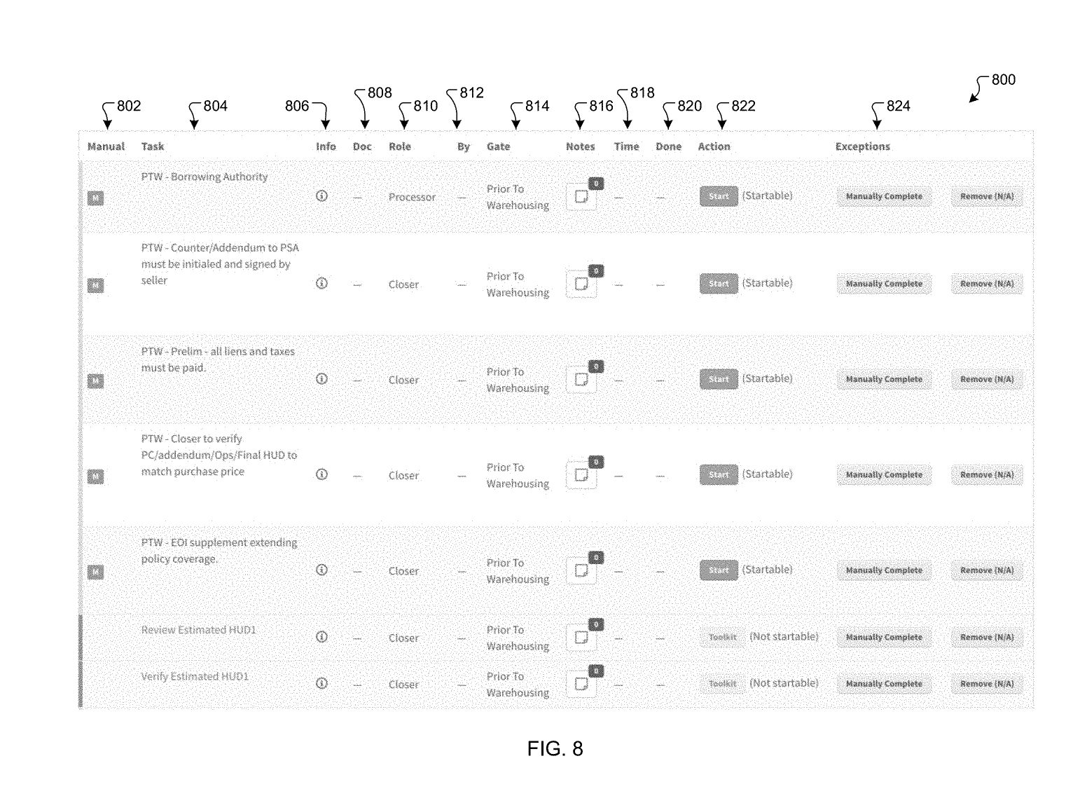

FIG. 8 is a screenshot of an example checklist index 800 for a user of the systems and methods described herein. In general, the checklist index 800 is a graphical user interface that includes a plurality of columns presenting information for a plurality of tasks for a project (e.g., a loan), with each task listed in a separate row. The checklist index 800 includes a manual column 802, a task column 804, an information column 806, a document column 808, a role column 810, a by column 812, a gate column 814, a notes column 816, a time column 818, a done column 820, an action column 822, and an exceptions column 824. The manual column 802 indicates whether a task was identified manually by a user or identified automatically by the systems and methods described herein. The task column 804 includes a brief description of each task. Additional information for the tasks is available by selecting a link in the information column 806. The document column 808 includes one or more links the user can select to obtain information related to the performance of the tasks. The by column 812 identifies the specific user who worked on and/or completed each task. The gate column 814 identifies dependencies associated with the various tasks. In the depicted example, the gate column 814 identifies for each task any subsequent task and/or project that cannot be performed until the listed task is completed. The notes column 816 includes one or more links to notes that users have added for the tasks. The time column 818 identifies a total amount of time that has been spent on each task and/or an amount of time it took to complete each task. The done column 820 indicates whether each task has been completed or not. The action column 822 includes one or more links that the user can click to work on a task. For example, when the user clicks a link in the action column 822, a toolkit or additional graphical user interface may be presented that assists the user with the performance of an associated task. The toolkit may request and/or accept information from the user and or guide the user through the performance of the task. The extensions column 824 allows the user to manually override one or more rules associated the tasks and/or to remove a task from the checklist index 800.

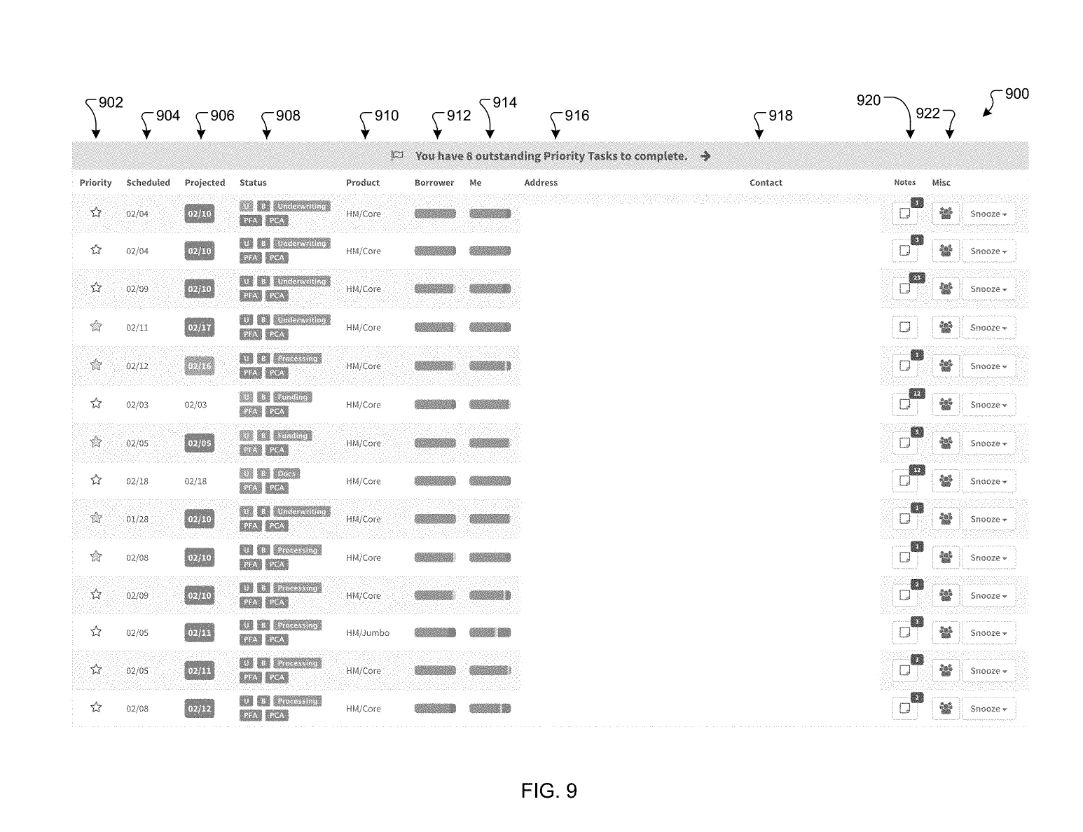

FIG. 9 shows a screenshot of an example pipeline 900 for a user of the systems and methods described herein. In general, the example pipeline 900 is a graphical user interface that includes a plurality of columns presenting information for a plurality of projects, with each project listed in a separate row. In certain implementations, the pipeline 900 provides a user with an overview or summary of various tasks or projects assigned to the user. The pipeline 900 includes a priority column 902, a scheduled column 904, a projected column 906, a status column 908, a product column 910, a customer column 912, a user column 914, an address column 916, a contact column 918, a notes column 920, and a miscellaneous column 922. The priority column 902 identifies a priority associated with each project in the pipeline 900. For example, the priority column 902 may flag a project as being high priority when the project is at risk of not being completed on time and/or requires additional resources to complete on time. The scheduled column 904 includes a target completion date for each project. The projected column 906 lists projected completion dates for each project, based on a projected amount of time and/or available resources it will take to complete the project. Such projections may be determined, for example, using the weights and/or queue loads associated with project tasks. In preferred examples, the projected column 906 includes color coding that provides a quick indication of a difference between the target completion date and the projected completion date for each project. For example, the projected column may include one or more warning colors (e.g., red or orange) to identify any tasks that are projected to be completed later than the target completion date.

In the depicted example, the status column 908 provides a high-level overview of the status of tasks assigned to one or more people and/or machines, for each project. For example, the status column may indicate whether the one or more people and/or machines have completed their assigned tasks for a project or whether the one or more people and/or machines must do additional work on these tasks. Color coding may be used to provide a quick indication of the status of the assigned tasks. For example, a green color may indicate that a person has completed his or her tasks, while a red or orange color may indicate that the person has not completed his or her tasks. Letters, words, or symbols may be used to identify specific people and/or machines associated with the project. In the context of a loan, for example, the letter “U” may be used to identify an underwriter and the letter “B” may be used to identify a borrower. A green region with a “U” label may indicate that the underwriter has performed all required tasks for the loan project.

Still referring to FIG. 9, the product column 910 identifies a product (if any) associated with each project. The customer column 912 and the user column 914 provide information about project tasks for a customer and a user, respectively. For example, the customer column 912 and the user column 914 may provide an indication of whether and how many project tasks have been completed and/or have not been completed, by the customer and the user, respectively. In the depicted example, the customer and user columns 912 and 914 present a separate bar that includes color coding for each project. For example, if the customer has completed all tasks for a project, the bar in the customer column 912 for that project may be entirely green. Likewise, if the user has not completed 25% of the tasks for a project, the bar in the user column 914 for that project may be 25% red. The customer and user columns 912 and 914 provide a quick indication of how much progress has been made and how much work remains to be done by the customer and the user, respectively, for each project. The address column 916 includes any address information associated with the projects. The contact column 918 includes contact information for one or more people associated with the projects. The notes column 920 includes links to notes associated with the projects. The miscellaneous column 922 may include links to information about the one or more people working on the various projects.

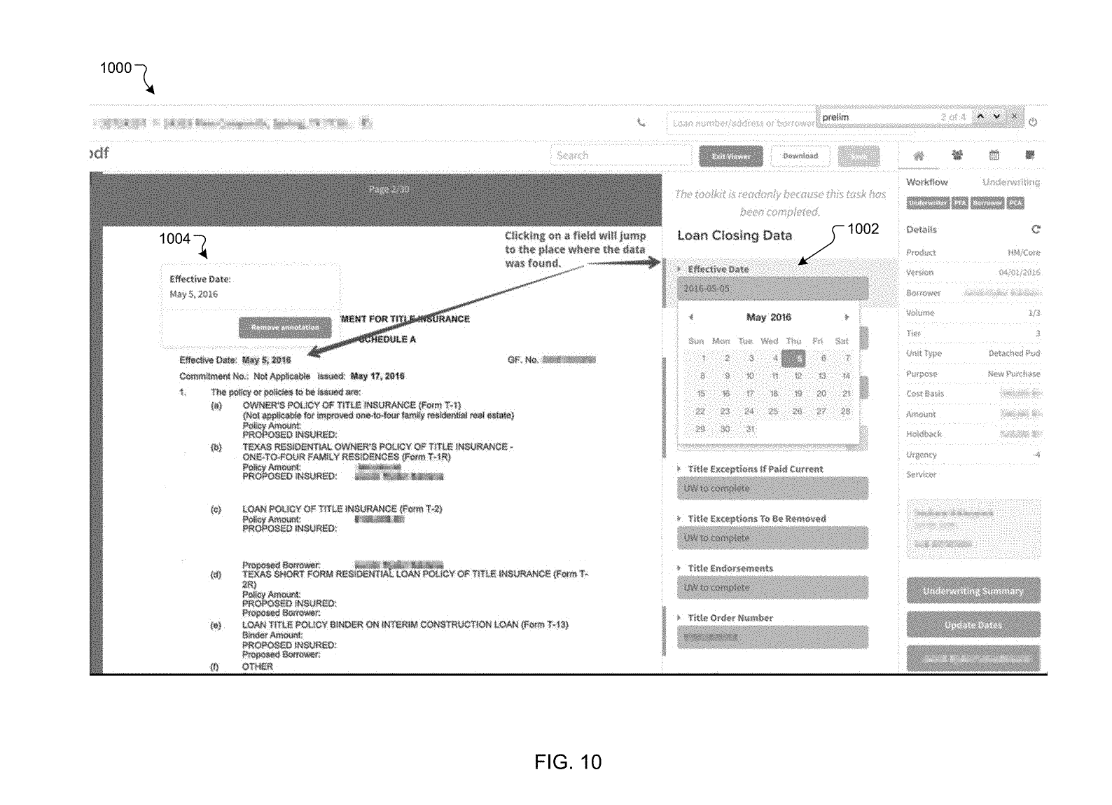

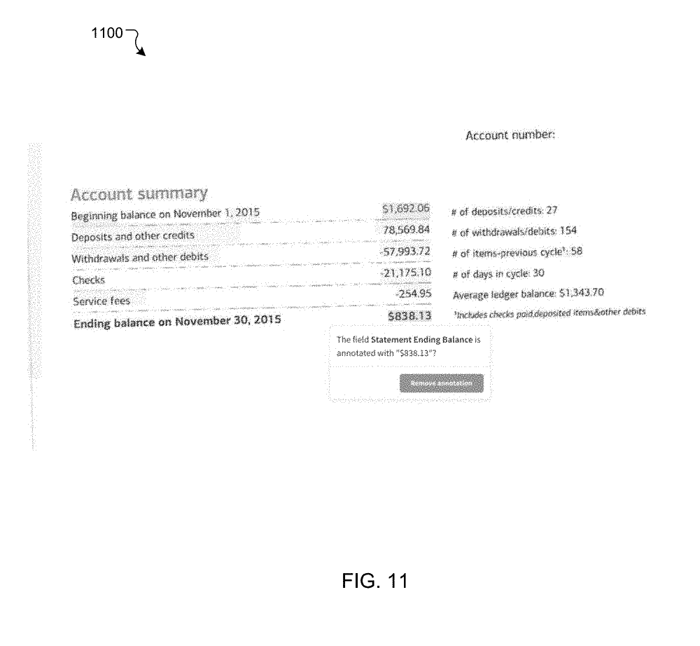

In various implementations, the systems and methods allow users to confirm information for a project by presenting the users with images of original documents containing the information. For example, referring to an example user interface 1000 shown in FIG. 10, if a user wishes to confirm that a date presented in a field 1002 is correct, the user may select (e.g., click or tap) the field and the systems and methods will present an image of an original document 1004 containing the date. Likewise, referring to FIG. 11, a user wishing to verify certain financial information may select the financial information in a user interface and be presented with a document 1100 that was a source of the information. This allows the user to verify the contents of original documents and confirm that any information in the documents is entered properly into the systems and methods for processing. Any inconsistencies between values in original documents and corresponding values entered into the systems and methods can be easily identified and corrected using this approach.

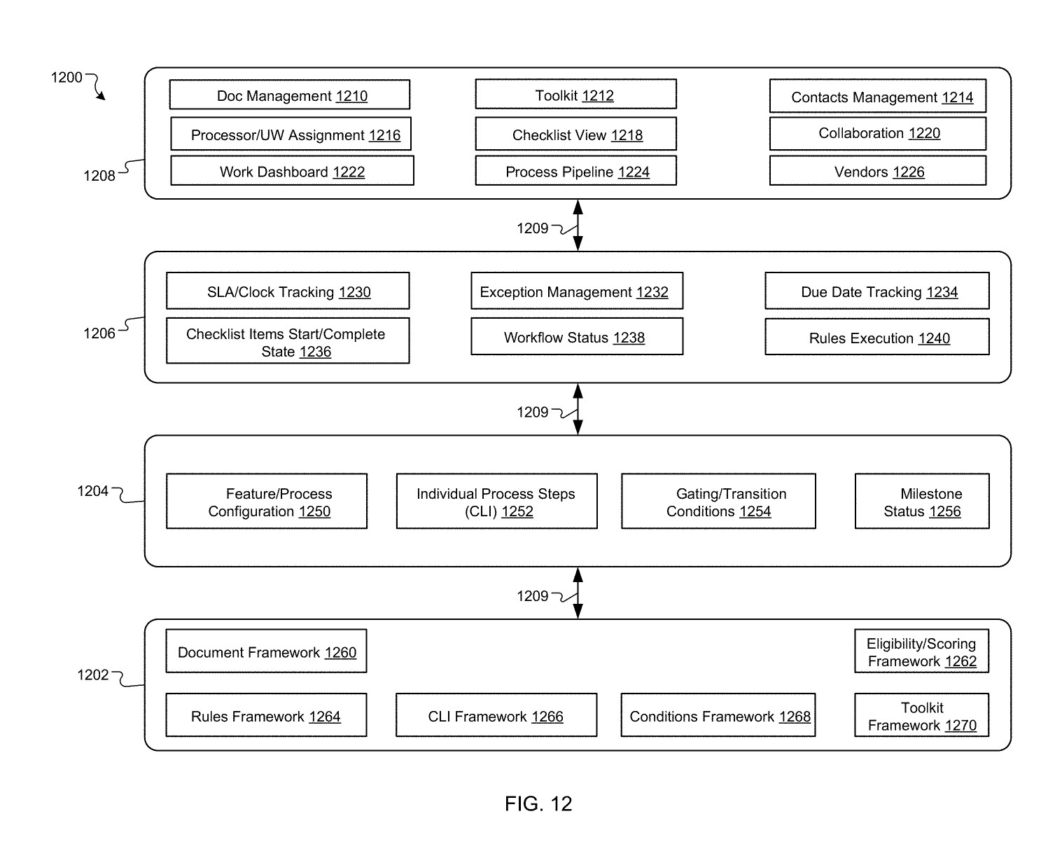

In certain examples, the systems described herein utilize a plurality of computation layers. Referring to FIG. 12, the computation layers of a system 1200 include a framework layer 1202, a configuration layer 1204, an orchestration layer 1206, and an execution layer 1208. Each layer may send and/or receive information from one or more of the other layers through communication channels 1209.

In general, the framework layer 1202 is configured to provide general purpose functionality in the form of software services or reusable components/libraries. Software services may include, for example, a pricing engine for determining loan conditions (e.g., interest rate) and a wiring engine for moving money between accounts. Reusable components/libraries may include, for example, software that enables data to be scanned or retrieved from documents and/or data to be verified by displaying original documents. In some instances, the framework layer 1202 provides one or more general purpose toolkits for users of the system 1200. In general, a toolkit is a user interface, a routine, and/or algorithm that guides a user through the performance of one or more tasks of a project.

The configuration layer 1204 is generally configured to inform users how to use the general purpose toolkits and/or customize the general purpose toolkits according to specific project parameters. For example, when combined with general purpose toolkits from the framework layer 1202, the configuration layer 1204 can customize the toolkits according to a specific project (e.g., by loan product, geography, or investor). In general, a toolkit framework or general purpose toolkit is a reusable component that may be customized by the configuration layer 1204 to generate specific toolkits for specific projects. In the context of a loan project, for example, a toolkit that requires six bank statements from a borrower in one loan product could be modified by the configuration layer 1204 (e.g., with a change to one line of code) to require three bank statements in a second loan product. The configuration layer 1204 may change what a toolkit requests from a borrower (e.g., tax returns), and what the toolkit presents to users of the systems and methods. Alternatively or additionally, the configuration layer 1204 may configure a toolkit to determine which investors may be eligible for a specific loan with a particular loan product (e.g., based on credit scores). The toolkit may be configured to make such determinations may be based on geography (e.g., location of a property and/or residence of a borrower).

The orchestration layer 1206 is generally configured to review the state of a plurality of projects and/or tasks, assign priorities to the projects and/or tasks, and/or optimize resources for performing the projects and/or tasks. For example, the orchestration layer may determine an optimal use of resources (e.g., people, machines, equipment, and/or supplies) that can be used to perform tasks and complete projects. In general, the orchestration layer 1206 is or includes a prioritization algorithm that can feed off tasks, project types, dates, available users, etc., to route work to different areas or users. In some examples, a ‘rush’ project or critical task can jump a priority queue. For example, as circumstances change, a task or project can be reprioritized ahead of other, lower priority tasks or projects.

The execution layer 1208 is preferably configured to provide assistance with the performance of tasks. For example, the execution layer may include one or more user interfaces that users of the system 1200 can use to complete assigned tasks and projects. Each of the framework layer 1202, the configuration layer 1204, the orchestration layer 1206, and the execution layer 1208 includes a plurality of modules configured to provide information and/or perform different tasks or functions, as described below.

The framework layer 1202 includes a document framework module 1260, an eligibility/scoring framework module 1262, a rules framework module 1264, a CLI framework module 1266, a conditions framework module 1268, and a toolkit framework module 1270. In general, the modules of the framework layer are or include flexible, low-level services or reusable components/libraries that allow users (e.g., administrative users) of the systems and methods to create different concepts. An administrative user may, for example, use the low-level services or reusable components/libraries to create one or more toolkits that may be used by other uses or machines to perform one or more tasks for a project. For example, the document framework module 1260 may be used to create a concept of different kinds of documents in a system. A user may use the document framework module 1260 to create a “bank statement” document, or a “tax return” document. This may allow the systems and methods to understand multiple aspects of created documents, like where to perform optical character recognition (OCR) in the document and/or how to extract one or more fields from the document. The approach may allow the systems and methods to know the format of a document (e.g., a bank statement) and/or to automatically look for and extract information from the document. The document framework module 1260 may be used to inform the systems and methods about how long a document is valid.

The eligibility/scoring framework module 1262 may be used to create different scoring/eligibility models for a product, such as a loan product. In general, a product may have a variety of criteria that must be satisfied to make a customer eligible for the product and/or may have certain scoring requirements that are used to determine one or more product parameters. In the context of a loan, for example, the eligibility/scoring framework module 1262 may define the eligibility requirements (e.g., first time homebuyer) and/or scoring requirements (e.g., requirements to obtain a specific interest rate) for a loan product.

The rules framework module 1264 may be used to create rules for one or more products. In general, rules are used in a variety of loan scenarios, including: enforcing credit policy requirements, enforcing regulatory requirements, and/or an arbitrary quality assurance requirement. Rules may be or include a set of data points and an arbitrary test or calculation to perform against the data, which can be used to determine a gradable outcome of the rule. In general, a rule requires a parameter to have a certain value. In the context of a loan, for example, a rule may require a borrower's income and/or credit rating to satisfy certain numerical values. In some examples, rules are used to ensure projects are performed with high quality. Rules may be used, for example, to ensure that (i) certain data exists, (ii) a file has been obtained, (iii) a step has been performed, and/or (iv) data is consistent between documents.

The CLI framework module 1266 may be used to create different checklist items or “tasks” associated with a project. In general, there are many different kinds of tasks, which can be assigned to different roles, can have different dependencies, and/or can be applicable in different circumstances. In the context of a loan, for example, a loan product may include a task of getting spousal consent, but only if the borrower is married and in a community property state. Such tasks and the conditions associated with the tasks may be created using the CLI framework module 1266.

The conditions framework module 1268 may be used to create different kinds of conditions for a product. In the context of a loan, for example, the conditions framework module 1268 may be used to specify one or more conditions (e.g., income or credit score) required to qualify for a loan product. The conditions may restrict different parts of workflows, capture data about the who/why of the condition, and/or capture the resolution path of the condition. The toolkit framework module 1270 is used to create different toolkits for different kinds of tasks, such as capturing data, verifying data, ensuring data is consistent, and/or ensuring rules are met.

The configuration layer 1204 includes a feature/process configuration module 1250, an individual process steps module 1252, a gating/transition conditions module 1254, and a milestone status module 1256. In general, the modules of configuration layer 1204 help users and supervisors of the systems and methods configure projects and tasks in a way that is maintainable and composable (e.g., users can assemble larger configurations from smaller configurations). In some examples, there is an implicit requirement that different configurations are preserved over time. Different configurations may be running concurrently.

In general, the feature/process configuration module 1250 is configured to interpret and/or define the configuration files. The feature/process configuration module 1250 may validate the configuration for a project, based on information provided in a configuration file.

The individual process steps module 1252 is configured to interpret and/or define the configuration of a most basic unit of work. For example, the individual process steps module 1252 may be used to interpret and/or define specific steps that must be performed for the various tasks of a project. The specific steps may be determined based on information in the configuration file.

The gating/transition conditions module 1254 is configured to interpret and/or define configurations when users are allowed to and not allowed to move between workflows and key actions. For example, the gating/transition conditions module 1254 may be used to group tasks together into sub-projects that are performed together and/or that must be completed before other tasks are performed. In the context of a loan, for example, tasks associated with underwriting approval may be assigned to a first group of tasks that must be completed before moving on to a second group of tasks (e.g., associated with funding).

The milestone status module 1256 is configured to interpret and/or define configurations for possible milestone paths, like a rush process, a preapproval process, or a normal loan order. In some examples, the milestone status module 1256 is used to generate and/or display a roadmap or a status overview for a project. The milestone roadmap or status overview may provide an easy way to see progress that has been made, work currently being done, and/or any tasks remaining for a project.

The orchestration layer 1206 includes a clock tracking module 1230, an exception management module 1232, a due date tracking module 1234, a checklist items start/complete state module 1236, a workflow status module 1238, and a rules execution module 1240. The clock tracking module 1230 is, in general, a backend system that calculates task expectations and/or due dates for tasks, which can be used for prioritization of tasks. Such information may be used, for example, to track progress of tasks/projects and compare the progress with expectations. Individuals or equipment performing the tasks may also be evaluated and/or monitored by comparing their performance with expectations.

The exception management module 1232 is configured to manage exception scenarios. For example, the exception management module 1232 may be used to determine or record data regarding who (e.g., a user) declared the exception, when and why the exception was declared, and/or any paths for resolving the exception. In general, an exception occurs when a rule is not satisfied. For example, a person processing a loan may decide that an unacceptable borrower credit rating is offset by favorable income and/or a lack of debt. The person processing that loan makes an exception when the loan is approved despite the borrower's poor credit rating. Such exceptions may be tracked using the exception management module 1232, so that data related to exceptions is collected and tracked. The exception management module 1232 may be used, for example, to determine how an exception pertains to dependencies between tasks so any related or dependent tasks can be properly prioritized.

The due date tracking module 1234 is configured to manage key dates for a project. In the context of a loan, for example, key dates may include signing dates, borrower acceptance dates, and underwriter acceptance dates. The checklist items start/complete state module 1236 is configured to monitor a state of checklist items. Users can use the checklist items start/complete state module 1236 input status information (e.g., started or completed) for a task.

The checklist items start/complete state module 1236 may provide or include a rules engine that can automatically identify a status of tasks and/or complete items. In some examples, the checklist items start/complete state module 1236 may identify tasks that are now startable (e.g., because of a data change) and/or manage dependencies.

The workflow status module 1238 is configured to monitor high level workflow status of a project, such as a loan project. In some implementations, the workflow status module 1238 may provide information to users and supervisors regarding the status of a project and/or provide warnings to users and supervisors if certain tasks are behind schedule. The rules execution module 1240 is configured to compute rules across all loans and can efficiently recompute rules across all loans. For example, when the conditions for a project change, the rules execution module 1240 may be used to ensure rules are being satisfied and/or flag any rules that are not being satisfied.

The execution layer 1208 includes a document management module 1210, a toolkit module 1212, a contacts management module 1214, a processor/UW assignment module 1216, a checklist view module 1218, a collaboration module 1220, a work dashboard module 1222, a process pipeline module 1224, and a vendors module 1226. Each of the modules in the execution layer may be or include a tool to help users perform one or more specific tasks. For example, the document management module 1210 is a tool that helps users manage documents (e.g., visibility, expiration, and/or classification) for projects. A user may use the document management module 1210 to view or obtain copies of documents, track when documents will expire, and/or to classify or categorize documents according to information provided in the documents.

The toolkit module 1212 is configured to provide users with specific kinds of toolkit. For example, the systems and methods may provide a user a toolkit for document extraction or for data verification etc. The toolkit module 1212 may provide users with toolkits that are customized versions of a toolkit framework. Such toolkits may be created using the techniques described herein with respect to the framework layer 1202 and the configuration layer 1204. The toolkit module 1212 may display the toolkits or otherwise make the toolkits available to users and/or equipment for performing various tasks.

The contacts management module 1214 is a tool that allows a user to manage or obtain contact information for a project. For example, a user may use the contacts management module 1214 to access or define names, phone numbers, and/or email addresses of individuals associated with the project.

The processor/UW assignment module 1216 may be or include a specific user interface or tool that allows a supervisor to manage assignment of specific tasks. For example, a supervisor may use the processor/UW assignment module 1216 to assign tasks to users and/or monitor workloads of users.

The checklist view module 1218 is a user interface or tool that allows a user to monitor or track progress associated with tasks assigned to the user. In some examples, the user may use the checklist view module 1218 to determine how much additional work is required for the user's tasks and/or whether any of the user's tasks are completed.

The collaboration module 1220 is a user interface or tool that allows a user or supervisor to identify a group of individuals who are working on a project and/or coordinate tasks among those specific individuals. For example, a supervisor may use the collaboration module 1220 to gather information about who is working together on a project and/or to determine whether any adjustments to the team are necessary. Such adjustments may be necessary, for example, when one or more project members is not available to work on the project (e.g., due to illness).

The work dashboard module 1222 is a user interface or tool that allows a user to view specific tasks that have been assigned to the user.

The process pipeline module 1224 is a user interface or tool that allows a user or supervisor to view task information for a specific phase of a project. Likewise, the process pipeline module 1224 may be used, for example, to view a listing of tasks and/or a listing of users for a particular project phase. The work dashboard module 1222, the process pipeline module 1224, and/or certain other modules within the execution layer 1208 (e.g., modules 1214 to 1220) may be used to generate one or more charts, tables, reports, or user interfaces for users and supervisors to view task or project information, including the example pipeline 900 in FIG. 9.

The vendors module 1226 is a user interface or tool for ordering 3rd party vendor data. For example, a user may use the vendors module 1226 to request information from or otherwise communicate with 3rd party vendors.

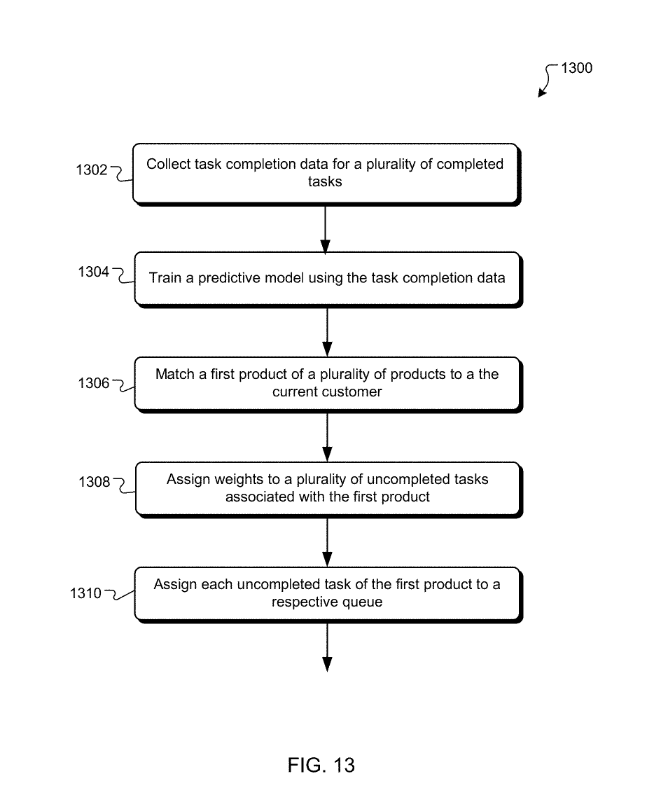

FIG. 13 is a flowchart of an example computer-implemented method 1300. The method includes collecting (step 1302) task completion data for a plurality of completed tasks. The task completion data for each task may be or include, for example, a task type, a task duration, and attributes of a previous customer (or other entity) for whom the task was performed. A predictive model (e.g., a classifier) is trained (step 1304) using the task completion data. In general, the predictive model is configured to determine a weight for an uncompleted task, given a task type and attributes of a current customer associated with the uncompleted task. A first product of a plurality of products is matched (step 1306) to the current customer. The first product and the other products include or are associated with conditions, tasks, and dependencies among the tasks. For example, regarding dependencies among the tasks, certain tasks may depend on other tasks and may not be able to be performed until the other tasks are completed, as described herein. Respective weights are assigned (step 1308) to a plurality of uncompleted tasks associated with the first product. The weight for each uncompleted task is determined by the predictive model, based on input data (e.g., project data 122) comprising a task type and attributes of the current customer associated with the uncompleted task. Each task in the plurality of uncompleted tasks is assigned (step 1310) to a respective queue, based on a calculated load of the queue and the weight for the uncompleted task. In general, the method 1300 allows tasks to be completed efficiently (e.g., in parallel) so that project deadlines can be met.

In certain implementations, the systems and methods described herein are able to extract information automatically from electronic documents. The systems and methods may convert an image of text into machine-encoded text or readable text (e.g., using optical character recognition). The readable text may then be scanned for information relevant to complete a task, and the information may be used to complete the task, as needed. In certain examples, a user manually identifies one or more data fields (e.g., by selecting or highlighting text) in a document, and the systems and methods scan and retrieve the information in the data fields. Alternatively or additionally, one or more data fields may be automatically identified in an electronic document, such as the document in FIG. 11, and values in the data fields may be automatically extracted from the document. Machine learning may be used to assist with this task. For example, copies of previous documents (e.g., bank statements, credit reports, etc.) may be retained as training data and used to train a classifier. The classifier may be or may use, for example, a linear classifier (e.g., Fisher's linear discriminant, logistic regression, Naive Bayes classifier, or perceptron), support vector machines (e.g., least squares support vector machines), a quadratic classifier, a kernel estimator (e.g., k-nearest neighbor), a boosting (meta-algorithm) classifier, a decision trees classifier (e.g., random forests), a neural networks classifier, a statistical classifier, and/or learning vector quantization. Once trained, the classifier may receive a new document or portion thereof as input and provide as output one or more locations in the document where relevant data may be found.

In some instances, the systems and methods provide users with images of documents used to provide information for a project. This way, when a user needs to later verify the accuracy of information, the user may view a document identified as being the source of the information. For example, a user wishing to confirm the accuracy of a numerical value may select a link in a user interface at or near the numerical value. The user may then be provided with an image of a document that includes the numerical value, for example, as shown in FIG. 11.

In some instances, after a product has been matched to a customer, it may become apparent that the product is no longer a good match for the customer. To address this situation, a different, more suitable product may be matched to the customer, using techniques described herein and/or known to those of ordinary skill in the art. For example, in the context of a loan project, it may become apparent after reviewing a customer's financial information that the customer no longer qualifies for the loan product that was originally matched to the customer. A different loan product, for which the customer is better suited, may then be matched to the customer. Preferably, any relevant information from the original product that still applies to the new product can be applied. For example, any information that was gathered while working on the original product and that is useful for the new product can be utilized. This reduces the need to repeat any project steps that the two products have in common, and reduces the chances that efforts will be duplicated. In the context of a loan, for example, certain financial information (e.g., credit rating, income, etc.) that was gathered from the customer while processing the first loan product can be applied to the second loan product.

Once the second product has been identified, any tasks that need to be completed are identified. The uncompleted tasks are assigned weights, using the classifier module 116, and the weights are used to assign tasks to the various queues, based on calculated loads for the queues, as described herein with respect to the original product. The process of assigning tasks to queues based on weights and calculated queue loads allows tasks for the second product to be performed efficiently and in parallel.

In various instances, the systems and methods monitor the status of a project and provide an estimated completion date for the project, which can be compared to the target completion date. This allows the systems and methods to predict whether a project will be completed on time (e.g., by the target closing date for a loan product). When it is predicted that the project will not be completed on time, one or more of the uncompleted tasks may be reassigned and/or reprioritized. For example, if an uncompleted task is presently assigned to a queue with a high load, the task may be assigned to a queue with a lower load. Tasks may also be reassigned to take further advantage of parallel processing. For example, two tasks that are assigned to a single queue but that could be performed in parallel may be reassigned to two separate queues, so that the tasks can be performed in parallel. Additionally or alternatively, a task that is currently rated as being a low priority may be reprioritized and given an new high priority rating. For example, the systems and methods may determine a priority of the particular task based on one or more attributes of the customer, the product, and/or property associated with the product. The particular task may then be inserted into (or moved within) a queue at a position based on the priority of the task. Such reprioritization may advance the task ahead of other, lower priority tasks in the queue, so that a user or processor associated with the queue will attempt to complete the task sooner.

In various examples, the systems and methods determine estimated completion dates based on, for example, weights associated with remaining tasks, any task dependencies, and/or loads associated with the queues. For example, the systems and methods may use the weights and/or loads to project how long it will take to proceed along each path of a tree diagram for the project, such as the tree diagrams shown in FIGS. 4A and 4B. The completion date for the project may then be determined based on the path requiring the most time to complete.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. For example, parallel processing may be used to perform multiple language detection methods simultaneously. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
collecting, using at least one computer processor, task completion data for a plurality of completed tasks, wherein the data for each completed task comprises respective task type and task duration;
training, using the at least one computer processor, a predictive model using the task completion data, the predictive model configured to determine weights for a plurality of tasks, wherein the weight for a task comprises at least one of a predicted amount of time for completing the task and a predicted complexity of the task, given a task type;
assigning, using the at least one computer processor, respective weights to a plurality of uncompleted tasks, the weight for each uncompleted task determined by the predictive model based on input data comprising a task type of the uncompleted task;
providing a plurality of queues for performing the uncompleted tasks;
calculating, using the at least one computer processor, an existing workload for each queue in the plurality of queues, wherein the existing workload for each queue (i) comprises an amount of work required to complete one or more tasks already assigned to the queue and (ii) is based on at least one weight determined by the predictive model for the one or more tasks already assigned to the queue; and
assigning, using the at least one computer processor, each task in the plurality of uncompleted tasks to a respective queue from the plurality of queues, based on the calculated existing workload of the queue, at least one capability of the queue, and the weight for the uncompleted task, wherein assigning each task to the respective queue comprises balancing workloads associated with the plurality of queues.

2. The method of claim 1, further comprising providing a respective graphical user interface (GUI) associated with each queue wherein the GUI comprises a progress indicator for each task in the queue.

3. The method of claim 2, further comprising updating a particular GUI based on a progress of tasks in the associated queue.

4. The method of claim 1, wherein the weight for an uncompleted task comprises the predicted time for completing the task.

5. The method of claim 1, wherein the weight for an uncompleted task comprises the predicted complexity of the task.

6. The method of claim 1, wherein a particular uncompleted task requires obtaining input data, the method comprising:
automatically identifying one or more data fields of an electronic document; and
automatically extracting respective values of the data fields from the document.

7. The method of claim 1, wherein a particular task is associated with one or more input data fields, the method comprising:
identifying an electronic source document from which the particular data field was extracted; and
providing a view of the data field in the source document in a graphical user interface.

8. The method of claim 1, further comprising determining that a completion date will not be met and, based thereon, reassigning one or more of the uncompleted tasks to one or more different queues in order to meet the completion date.

9. The method of claim 1, wherein assigning a particular task to a particular queue comprises:
determining a priority of the particular task; and
inserting the particular task into the particular queue at a position based on the priority of the task.

10. The method of claim 9, wherein the position is ahead of one or more other tasks in the queue.

11. The method of claim 1, wherein the predictive model is a statistical classifier.

12. The method of claim 1, wherein assigning a task in the plurality of uncompleted tasks comprises assigning the task after a prior task has been completed.

13. The method of claim 1, further comprising identifying at least two tasks among the uncompleted tasks that can be performed in parallel, and wherein assigning each task comprises assigning each of the at least two tasks to a different queue from the plurality of queues.

14. A system comprising:
a non-transitory computer readable medium having instructions stored thereon; and
a data processing apparatus configured to execute the instructions to perform operations comprising:
collecting, using at least one computer processor, task completion data for a plurality of completed tasks, wherein the data for each completed task comprises respective task type and task duration;
training, using the at least one computer processor, a predictive model using the task completion data, the predictive model configured to determine weights for a plurality of tasks, wherein the weight for a task comprises at least one of a predicted amount of time for completing the task and a predicted complexity of the task, given a task type;
assigning, using the at least one computer processor, respective weights to a plurality of uncompleted tasks, the weight for each uncompleted task determined by the predictive model based on input data comprising a task type of the uncompleted task;
providing a plurality of queues for performing the uncompleted tasks;
calculating, using the at least one computer processor, an existing workload for each queue in the plurality of queues, wherein the existing workload for each queue (i) comprises an amount of work required to complete one or more tasks already assigned to the queue and (ii) is based on at least one weight determined by the predictive model for the one or more tasks already assigned to the queue; and
assigning, using the at least one computer processor, each task in the plurality of uncompleted tasks to a respective queue from the plurality of queues, based on the calculated existing workload of the queue, at least one capability of the queue, and the weight for the uncompleted task, wherein assigning each task to the respective queue comprises balancing workloads associated with the plurality of queues.

15. The system of claim 14, wherein the weight for an uncompleted task comprises the predicted time for completing the task.

16. The system of claim 14, the operations comprising determining that a completion date will not be met and, based thereon, reassigning one or more of the uncompleted tasks to one or more different queues in order to meet the completion date.

17. The system of claim 14, wherein assigning a task in the plurality of uncompleted tasks comprises assigning the task after a prior task has been completed.

18. The system of claim 14, the operations comprising identifying at least two tasks among the uncompleted tasks that can be performed in parallel, and wherein assigning each task comprises assigning each of the at least two tasks to a different queue from the plurality of queues.

19. The system of claim 14, wherein the predictive model is a statistical classifier.

20. A computer program product stored in one or more non-transitory storage media for controlling a processing mode of a data processing apparatus, the computer program product being executable by the data processing apparatus to cause the data processing apparatus to perform operations comprising:
collecting, using at least one computer processor, task completion data for a plurality of completed tasks, wherein the data for each completed task comprises respective task type and task duration;
training, using the at least one computer processor, a predictive model using the task completion data, the predictive model configured to determine weights for a plurality of tasks, wherein the weight for a task comprises at least one of a predicted amount of time for completing the task and a predicted complexity of the task, given a task type;
assigning, using the at least one computer processor, respective weights to a plurality of uncompleted tasks, the weight for each uncompleted task determined by the predictive model based on input data comprising a task type of the uncompleted task;
providing a plurality of queues for performing the uncompleted tasks;
calculating, using the at least one computer processor, an existing workload for each queue in the plurality of queues, wherein the existing workload for each queue (i) comprises an amount of work required to complete one or more tasks already assigned to the queue and (ii) is based on at least one weight determined by the predictive model for the one or more tasks already assigned to the queue; and
assigning, using the at least one computer processor, each task in the plurality of uncompleted tasks to a respective queue from the plurality of queues, based on the calculated existing workload of the queue, at least one capability of the queue, and the weight for the uncompleted task, wherein assigning each task to the respective queue comprises balancing workloads associated with the plurality of queues.
